(19) United States
(12) Patent Application Publication
(10) Pub. No.: US 2014/0311302 A1
(43) Pub. Date: Oct. 23, 2014

(54) ATTACHMENT FOR ROTATING TOOL

(71) Applicant: VESSEL INDUSTRIAL CO., LTD., Osaka (JP)

(72) Inventors: Yasuaki TAGUCHI, Osaka-shi (JP); Jiro TAGUCHI, Osaka-shi (JP)

(21) Appl. No.: 13/864,846

(22) Filed: Apr. 17, 2013

(51) Int. Cl. B25B 23/00; B25B 23/12; B25B 13/06

(52) U.S. Cl. CPC B25B 23/0035; B25B 13/06; B25B 23/12
USPC 81/437; 81/125

(57) ABSTRACT

The socket holder comprises a cylindrical socket section, and a hexagonal prism-shaped shank section which is held in the socket section for transmission of torque to the socket section, and receives torque from a rotating tool. The shank section is detachably fitted to the socket section via a retention mechanism composed of a coil spring and a steel ball. The front end of the shank section is fitted with a thin, cylindrical magnet.

### TECHNICAL FIELD

The present invention relates to an attachment which is detachably attached to a rotating tool such as a power tool or a pneumatic tool for tightening and loosening a screw through transmission of rotation torque, and more particularly to an attachment suitable for use with a screw such as a tapping screw or a drill screw used to join, for example, iron sheets together.

### BACKGROUND ART

A self-drilling tapping screw, which is generally called a drill screw, has a cutting edge at its tip and is thus capable of screw tightening without the necessity of creating a so-called tapping hole in an iron sheet or the like. In general, the drill screw is so designed that the number of rotations for the cutting edge to dig into such a sheet is in the neighborhood of 2500. Therefore, in the case of using an electric impact tool, it will be necessary to make rpm adjustment in conformity with that number while keeping the tool in a pressed state. At this time, if the number of rotations is unduly high, the cutting edge may seize up into lockup, and, on the other hand, if the number of rotations is unduly low, the screw may take an eternity to be threaded into the sheet.

Moreover, it is important that the electric impact tool be pressed in a straight position against a target member (iron sheet). If it is pressed in a slanting position, the screw may topple, or the cutting edge may accidentally slip, which poses the risk of damage to the member. Furthermore, drill screws, having been heat-treated, cost more per screw than do commonly-used machine screws. As a consequence, there is an increasing demand for a low-loss attachment for rotating tools that is less prone to a failure of screw threading and accidental separation from a rotating tool and is thus capable of stable operation.

In order to satisfy such a requirement, it is customary to impart a magnetic force to a bit or a socket part designed for rotating tools. In this way, while a drill screw can be held and set in an intended tightening position with one hand of a user, a rotating tool can be pressed in a straight position against a target member with the other hand. This makes it possible to achieve screw tightening with stability while preventing damage to the member and occurrence of seize-up and accidental separation of an expensive screw.

In U.S. Pat. No. 7,044,031, there is disclosed a socket tool capable of holding a flanged hexagon head screw (a screw having a hexagonal head) by a magnet incorporated in its socket section. In this construction, a drill screw is held under a magnetic force exerted by the magnet, wherefore it never occurs that the screw will be accidentally detached or topple during operation. Accordingly, screw-tightening operation can be achieved with stability.

However, the socket tool disclosed in U.S. Pat. No. 7,044,031 poses the following problem. That is, cuttings of iron discharged during the time a tapping hole is created by the cutting edge of the drill screw are constantly attracted to the magnet. When an iron sheet or the like is drilled by the cutting edge at the tip of the drill screw, iron cuttings are produced and discharged, along the threaded portion, to the outside. The iron cuttings, being discharged in the form of fine chippings, are widely scattered around. In the case of performing screw tightening operation by the socket tool disclosed in U.S. Pat. No. 7,044,031, at the instant of removing the socket tool following the completion of screw tightening, iron chippings are attracted to the magnet. Once the magnet has attracted iron chippings, the adherent iron chippings cannot be easily removed under the magnetic force of the magnet. In the socket tool in particular, the magnet is situated in a deep, inner part of the socket section. Therefore, once the magnet has attracted iron chippings, it will be difficult to remove the adherent iron chippings properly.

A buildup of iron cuttings in the form of chippings causes, in addition to lack of stability in the retention of the drill screw, reduction in the area of contact with the hexagon head, which may lead to stripping of the hexagon head or a wearing down of the socket section. Moreover, the iron chippings produced by the drilling action of the cutting edge of the drill screw are like curls of iron with sharp edges, wherefore the iron chippings may be stuck in user's fingers during their removal, which poses the risk of injury. Such a risk is especially high when the magnet is situated in a deep, inner part of the socket section.

The problem associated with adhesion of iron chippings arises also in screw-tapping operation involving a step of preparing a hole which is smaller in diameter than a screw in a sheet. After all, the adhesion of iron chippings to a magnet has become a major problem in tapping operation.

Moreover, included in drill screws and tapping screws are a pan head screw and a truss head screw that are tightened up by a cross- or square-recessed bit for rotating tools. Also in the case of using such a screw, as a screw-holding method, for example, a technique to magnetize a cutting tip of a rotating tool bit by a magnet or a technique to bring a rotating tool bit into contact with a magnet for magnetization is adopted. However, as is the case with the socket tool, the cross- or square-recessed rotating tool bit also poses problems such as finger injury that may occur during removal of iron chippings and a failure of removal of iron chippings caused by re-adhesion of iron chippings.

In European Patent Publication No. 2468452A2, there is disclosed a socket tool characterized in that a magnet holder for holding a magnet is configured for forward motion to protrude from a socket section. At the end of operation, the magnet holder is moved forward by actuating a lever to cause a magnet portion to jut out. In this way, removal of iron chippings can be achieved with ease.

### SUMMARY OF INVENTION

### Technical Problem

However, in the socket tool disclosed In European Patent Publication No. 2468452A2, the magnet holder needs to be movable between a holder advanced position (in which the magnet portion protrudes) and a holder retracted position (in which the magnet portion stays in a deep, inner part of the socket section), and also there is a need to provide a locking mechanism for locking the magnet holder in each of that positions with consequent increase in structural complexity. Moreover, if iron chippings find their ways into such a locking mechanism, the magnet holder cannot be locked in place properly, with the result that the tool becomes incapable of functioning as intended. Furthermore, with the provision of such a locking mechanism, inconveniently, the locking mechanism needs to be released every time the magnet holder is moved.

The present invention has been devised in view of the problems as mentioned supra, and accordingly an object of the present invention is to provide an attachment for rotating tools (socket holder (nut setter), bit holder) characterized in that it is capable of holding a drill screw or a tapping screw by a magnet, yet is simple in structure, and features easy removal of iron chippings.

### Solution to Problem

In order to accomplish the above object, the following technical means is adopted for the implementation of the present invention.

An attachment for rotating tools according to one aspect of the present invention is attached to a rotating tool for rotation of a fastening member. This attachment is composed of a cylindrical socket section, and a rodlike shank section which is slidably held in the socket section for transmission of torque to the socket section, and receives torque from the rotating tool. The front end of the shank section is fitted with a magnet member. The socket section includes a sliding cavity in which the shank section slides in the direction of the axis of rotation relative to the socket section, and a holding portion disposed at the front end of the socket section, for holding a fastening member in engagement. The attachment includes holding means disposed in at least one of that part of the socket section which bears the sliding cavity and the shank section, for holding the shank section for free detachment from the socket section.

An attachment for rotating tools according to another aspect of the present invention includes, instead of the aforestated holding means, slidably holding means for holding the shank section for free sliding motion in the socket section in a manner such that the shank section is able to move toward and away from the holding portion, and that the shank section moves away from the holding portion as the rotating tool is moved in a direction to move the fastening member away from the holding portion.

Preferably, in this construction, the slidably holding means holds the shank section for free sliding motion in the socket section, is disposed in at least one of that part of the socket section which bears the sliding cavity and the shank section, and holds the shank section for free detachment from the socket section.

More preferably, in this construction, the shank section can be moved away from the holding portion until it reaches a limit position where the shank section is restrained against detachment from the socket section.

More preferably, in this construction, the shank section is free to slide between an approach position toward the holding portion and a separation position away from the holding portion.

More preferably, in this construction, the fastening member is any one of a hexagon head drill screw, a hexagon head tapping screw, and a hexagon head drilling tapping screw, and thus the holding portion has the form of a recess of hexagonal profile.

More preferably, in this construction, the fastening member is a bit for rotating any one of a cross- or square-recessed head drill screw, a cross- or square-recessed head tapping screw, and a cross- or square-recessed head drilling tapping screw, and thus the holding portion is given a cross-like or rectangular profile, and has a bit holder part for holding the bit.

### Advantageous Effects of Invention

According to the present invention, there is provided an attachment for rotating tools that is capable of holding a drill screw or a tapping screw by a magnet, is simple in structure, and features easy removal of iron chippings.

### BRIEF DESCRIPTION OF DRAWINGS

FIGS. 1A through 1C show a three-view drawing of an attachment for rotating tools (socket holder) in accordance with the first embodiment of the present invention;

FIG. 2 is an enlarged sectional view of the socket holder shown in FIGS. 1A through 1C;

FIG. 3 is a perspective view of the socket holder shown in FIGS. 1A through 1C;

FIG. 4 is an exploded perspective view of the socket holder shown in FIGS. 1A through 1C;

FIGS. 5A through 5C show a three-view drawing of an attachment for rotating tools (socket holder) in accordance with the second embodiment of the present invention;

FIG. 6 is an enlarged sectional view of the socket holder shown in FIGS. 5A through 5C;

FIG. 7 is a perspective view of the socket holder shown in FIGS. 5A through 5C (with its magnet set in approach position);

FIG. 8 is a perspective view of the socket holder shown in FIGS. 5A through 5C (with its magnet set in separation position);

FIG. 9 is an exploded perspective view of the socket holder shown in FIGS. 5A through 5C;

FIGS. 10A through 10D are explanatory drawings of operation of the attachment shown in FIGS. 5A through 5C;

FIGS. 11A through 11C show a three-view drawing of an attachment for rotating tools (socket holder) in accordance with the third embodiment of the present invention;

FIG. 12 is a perspective view of the socket holder shown in FIGS. 11A through 11C (with its magnet set in approach position);

FIG. 13 is a perspective view of the socket holder shown in FIGS. 11A through 11C (with its magnet set in separation position); and

FIGS. 14A through 14D are explanatory drawings of operation of the socket holder shown in FIGS. 11A through 11C.

### DESCRIPTION OF EMBODIMENTS

Hereinafter, an attachment for rotating tools in accordance with embodiments of the present invention will be described in detail with reference to drawings. In the following descriptions of different embodiments, similar reference symbols are utilized in designating corresponding constituent components (parts) that are identical in name and function. Therefore, overlapping detailed descriptions thereof will be omitted.

While the following descriptions deal with, as the attachment for rotating tools, an attachment called a socket holder or a nut setter, the application of the present invention is not limited to the socket holder and the nut setter. The present invention is also applicable to a bit holder built as an attachment for rotating tools that is attached to a rotating tool for rotating a cross- or square-recessed head drill screw, a cross- or square-recessed head tapping screw, a cross- or square-recessed head drilling tapping screw, or the like via a bit acting as a fastening member (a member used for fastening purposes).

### First Embodiment

Hereinafter, a description will be given as to a socket holder 100 that exemplifies an attachment for rotating tools in accordance with the first embodiment of the present invention.

[Structure of Socket Holder]

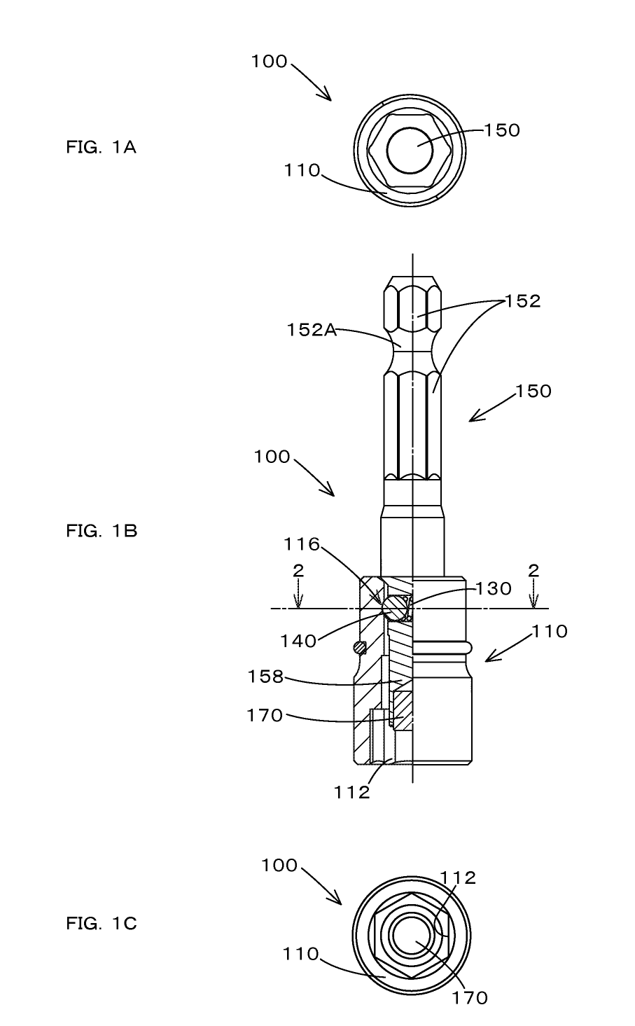

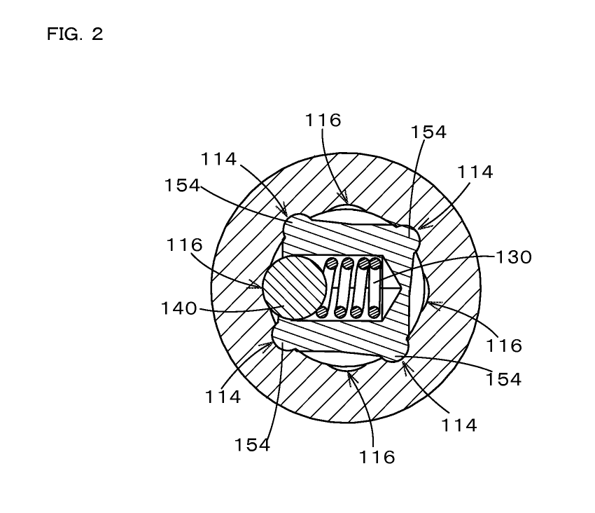

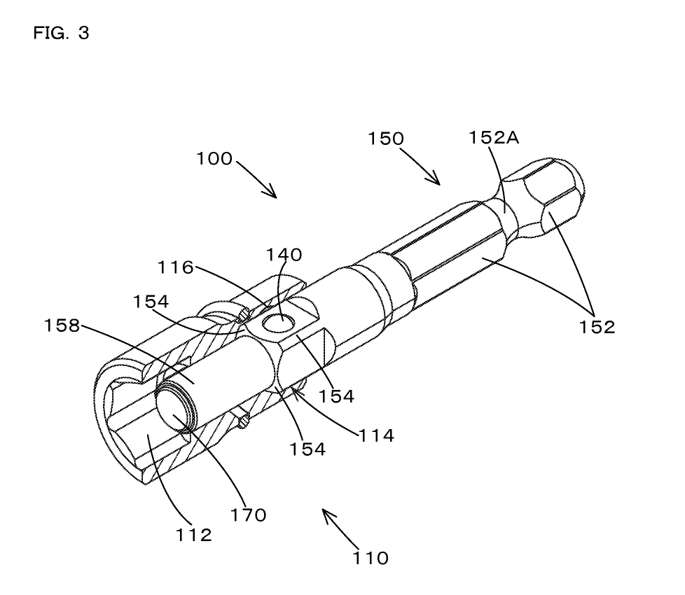

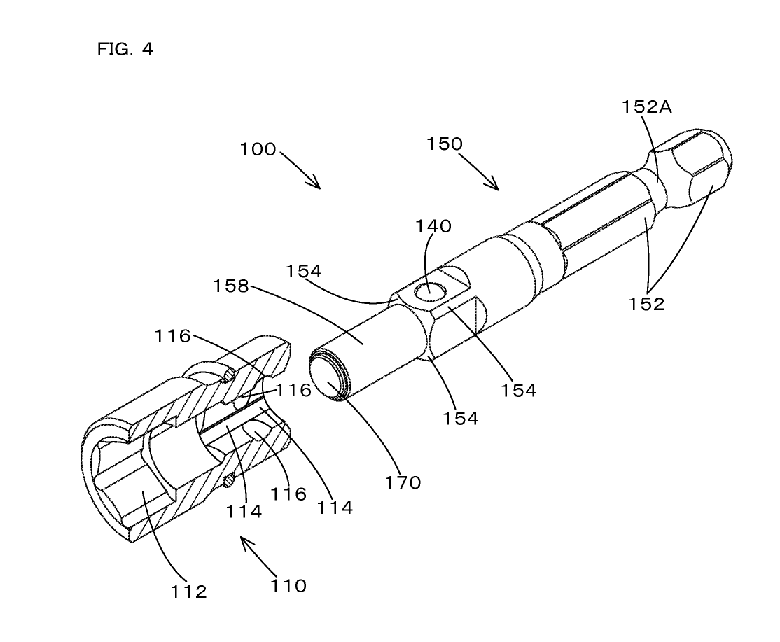

FIGS. 1A through 1C show a three-view drawing of the socket holder 100 that exemplifies the attachment for rotating tools in accordance with the first embodiment of the present invention. FIG. 1A is a top view of the socket holder 100, FIG. 1B is a side view showing part of the socket holder 100 in section, and FIG. 1C is a bottom view of the socket holder 100. Moreover, FIG. 2 is an enlarged sectional view taken along the line 2-2 in FIG. 1B. In addition, FIG. 3 is a perspective view of the socket holder 100, with a socket section 110 shown in section, and FIG. 4 is an exploded perspective view of the socket holder 100, with a shank section 150 drawn out of the socket section 110.

The socket holder 100 is an attachment which is attached to a rotating tool (an electric impact tool or the like) for rotating any one of a hexagon head drill screw, a hexagon head tapping screw, and a hexagon head drilling tapping screw (in what follows, the drill screw will be described as exemplary).

As shown in FIGS. 1A through 4, the socket holder 100 is broadly composed of a cylindrical socket section 110 and a rodlike shank section 150 which is detachably held in the socket section 110 for transmission of torque to the socket section 110, and receives torque from a rotating tool. More specifically, the socket holder 100 comprises the shank section 150 which is a shank located toward one end of the socket holder 100 in the direction of the axis of rotation, to which is attached a rotating tool, and the socket section 110 located toward the other end of the socket holder 100, which has a holding portion 112 that engages with the head of a flanged hexagon-head drill screw. The socket section 110 and the shank section 150 are each constructed of a single structural component formed by means of mold casting or otherwise. A coil spring 130 and a steel ball 140 provided in the shank section 150, and a ball engagement portion 116 provided in the socket section 110 constitute a retention mechanism (holding means). The shank section 150 is detachably fitted to the socket section 110 via the retention mechanism.

[Shank Section]

Now, the shank section 150 will be described in greater detail. The shank section 150 is composed of a first torque transmission portion 152 to which is transmitted torque from a rotating tool, a second torque transmission portion 154 for transmitting torque to the socket section 110, the steel ball 140 which is engaged in the ball engagement portion 116 provided in the socket section 110, the coil spring 130 for pressing the steel ball 140, and a magnet holding portion 158 for holding a magnet 170.

The first torque transmission portion 152 is given the form of a hexagonal prism (although there is no particular limitation, a hexagonal prism of 6.35 mm in opposite side length). The second torque transmission portion 154 is given the form of a quadrangular prism, and has, at each of its four corners, a convexity which is engaged in the ball engagement portion 116. The first torque transmission portion 152 and the second torque transmission portion 154 are made of the same structural components. Note that the first torque transmission portion 152 and the second torque transmission portion 154 may be identically shaped like a hexagonal prism.

The first torque transmission portion 152 is formed with a smaller-diameter cylindrical retainer part 152A for the retention of a retention ball disposed in a mounting recess of a rotating tool (generally a recess of hexagonal profile in a part called anvil). The retainer part 152A is radiused at both ends in conformity with the diameter of the retention ball in the anvil, and merges smoothly with the other hexagonal prism-shaped part of the first torque transmission portion 152.

The thin, cylindrical magnet 170 is fixed to the front-end side of the shank section 150 (the side opposite from the rotating tool), with the magnet holding portion 158 lying between them.

More specifically, the shank section 150 is a member constructed by casting an alloy steel having resistance to abrasion and toughness into form comprising a hexagonal-profile part and a quadrangular-profile part, the four corners of which are each formed with a convexity. One end of the shank section 150 in the rotation-axis direction is formed with the retainer part 152A for attachment to the anvil of the rotating tool, and the other end thereof is fitted with the powerful magnet 170 made from neodymium. Moreover, in order for the shank section 150 to be held in the socket section 110, the shank section 150 is provided with the steel ball 140 which is engaged in the ball engagement portion 116 of the socket section 110, and the coil spring 130 for pressing the steel ball 140 toward the socket section 110. The steel ball 140 and the coil spring 130 are disposed at one of the side surfaces of the quadrangular prism-shaped second torque transmission portion 154.

[Socket Section]

Now, the socket section 110 will be described in greater detail. The socket section 110 includes a sliding cavity in which the shank section 150 slides in the rotation-axis direction relative to the socket section 110, and the holding portion 112 in the form of a recess of hexagonal profile for holding a hexagonal head part of a drill screw acting as a fastening member in engagement. The sliding cavity is composed of a torque transmission portion 114 to which is transmitted torque from a rotating tool through the second torque transmission portion 154 of the shank section 150, and the ball engagement portion 116 which engages with the steel ball 140 of the shank section 150. The second torque transmission portion 154 is defined by the convexities at the four corners, respectively, of its quadrangular-prism form, wherefore four torque transmission portions 114 are provided in the inner periphery of the sliding cavity in alignment with their respective second torque transmission portions 154. Moreover, the torque transmission portion 114 and the second torque transmission portion 154 are arranged in 90-degree rotationally symmetrical relation, wherefore the shank section 150 can be inserted into the socket section 110 on a 90-degree turn basis. Therefore, four ball engagement portions 116 are provided in the inner periphery of the sliding cavity relative to a single steel ball 140. However, each of the torque transmission portion 114, the second torque transmission portion 154, and the ball engagement portion 116 is not limited to a four-piece configuration.

More specifically, the socket section 110, which is constructed of an alloy steel having resistance to abrasion and toughness, has the holding portion 112 for holding a drill screw or the like formed at one end in the rotation-axis direction, and has the torque transmission portion 114 (concavities corresponding to four corners of the quadrangular-prism form) formed at the other end by means of stamping. Upon the engagement of the second torque transmission portion 154 (convexities at four corners of the quadrangular-prism form) of the shank section 150 in the torque transmission portion 114, transmission of torque from the rotating tool can be effected.

Moreover, in order for the shank section 150 to be held in the socket section 110, the socket section 110 has formed in its inner periphery the ball engagement portion 116 which engages with the steel ball 140 of the shank section 150.

[Retention Mechanism]

Thus, the steel ball 140 is pressed into engagement in the ball engagement portion 116 by the coil spring 130, whereby the shank section 150 can be prevented from being accidentally detached from the socket section 110. In the event that the shank section 150 suffers damage, or when it is desired to remove iron chippings adherent to the magnet 170 as will hereafter be described, the shank section 150 is removed from the socket section 110. In this case, when the shank section 150 is pulled so as to come out of the socket section 110, the steel ball 140 presses the coil spring 130 down for disengagement from the ball engagement portion 116, and consequently the shank section 150 can be removed from the socket section 110. In this way, following the completion of separation of the shank section 150 from the socket section 110, it is possible to achieve replacement of the shank section 150, as well as to remove iron chippings adherent to the magnet 170.

It is noted that the coil spring 130 has a resilience in an extent sufficient to prevent easy separation of the shank section 150 from the socket section 110 (for example, separation caused by gravitation alone) on one hand, and has a resilience in an extent sufficient to allow the shank section 150 to come out of the socket section 110 when it is pulled on as has already been described, on the other hand.

[Operation of Socket Holder]

The operation of the thusly constructed socket holder 100 of the first embodiment will be explained.

In the course of threading a drill screw, after an operator becomes aware of adhesion of iron chippings to the magnet 170, he/she removes the socket holder 100 from the rotating tool.

When the shank section 150 of the socket holder 100 is pulled by the operator to detach it from the socket section 110, then the steel ball 140 presses the coil spring 130 down for disengagement from the ball engagement portion 116, and consequently the shank section 150 comes out of the socket section 110, whereupon separation between the shank section 150 and the socket section 110 is achieved. At this time, while the second torque transmission portion 154 slides in the torque transmission portion 114, the shank section 150 is drawn out of the socket section 110, and eventually separation between the shank section 150 and the socket section 110 can be achieved.

Iron chippings adherent to the magnet 170 at the tip of the shank section 150 released from the socket section 110 can be removed by the operator. In this case, if the shank section and the socket section do not exist in isolation from each other, since the magnet is situated in a deep, inner part of the socket section, the iron chipping may be stuck in the fingers of the operator during the removal with consequent injury. In contrast, where the shank section 150 and the socket section 110 exist in isolation from each other, such a possibility of injury can be minimized. Moreover, the socket holder 100 is capable of separation between the shank section and the socket section without the necessity of employing a complex system, and therefore exhibits high durability.

[Advantageous Effects]

As described heretofore, according to the socket holder 100 of the first embodiment, in the course of threading a drill screw, even if iron chippings adhere to the magnet 170, since the shank section 150 can be detached from the socket section 110 with ease, it is possible to release the tip of the shank section 150 from the socket section 110 and thereby remove iron chippings adherent to the magnet 170 with safety. Particularly, the separation between the shank section 150 and the socket section 110 can be achieved in a very simple structure.

### Second Embodiment

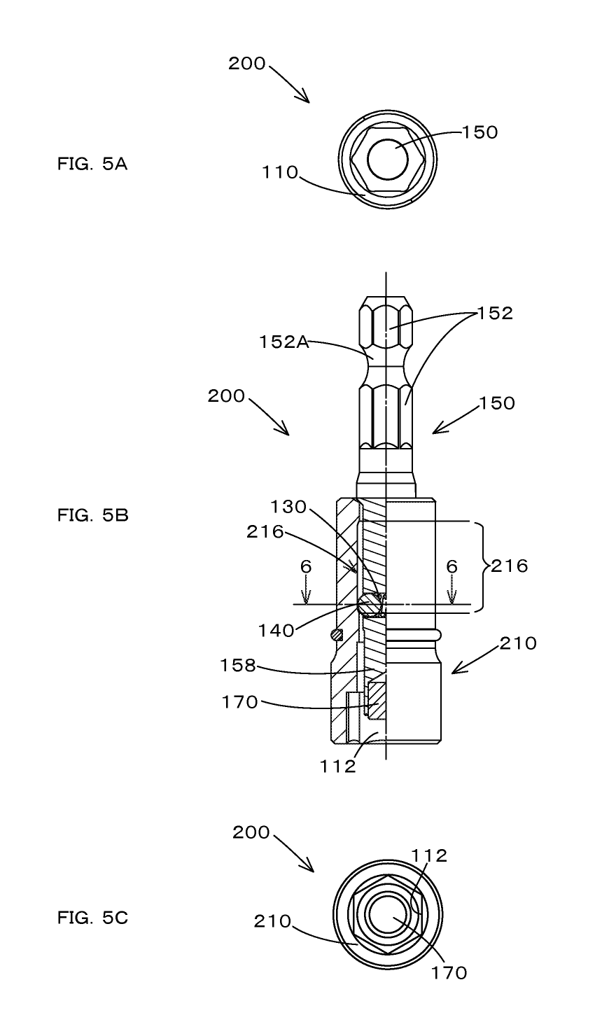

Hereinafter, a description will be given as to a socket holder 200 that exemplifies an attachment for rotating tools in accordance with the second embodiment of the present invention. The socket holder 200 differs from the socket holder 100 of the first embodiment in that its shank section 150 is detachably and slidably fitted to a socket section 210 via a retention mechanism. The constituent components (parts) of the socket holder 200 common to those of the socket holder 100 will be identified with the same reference symbols. These components are identical in name and function with the corresponding ones of the socket holder 100. Therefore, overlapping descriptions will be omitted. For example, the shank section 150 of the socket holder 200 and the shank section of the socket holder 100 are identically configured, except for the lengths of the first torque transmission portion 152 and the second torque transmission portion 154 in the rotation-axis direction, wherefore the shank section 150 of the socket holder 200 will not be described hereinbelow. Moreover, in what follows, FIGS. 5A through 5C, FIG. 6, FIGS. 7 and 8, and FIG. 9 correspond to FIGS. 1A through 1C, FIG. 2, FIG. 3, and FIG. 4, respectively.

[Structure of Socket Holder]

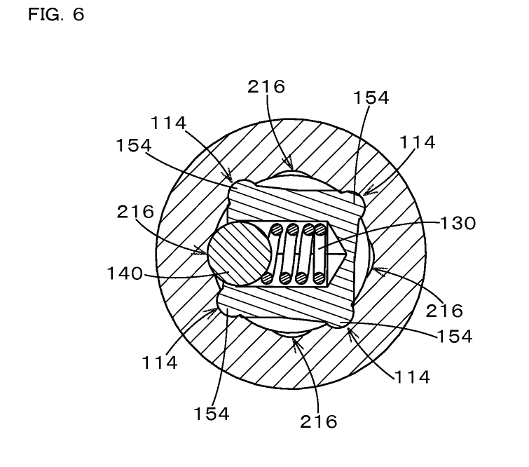

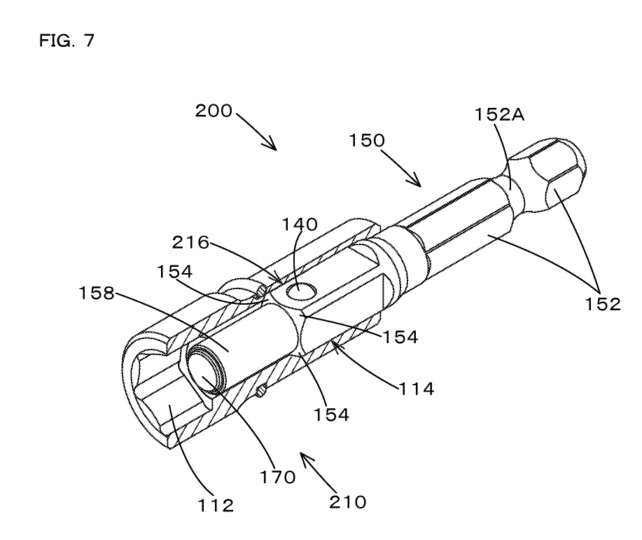

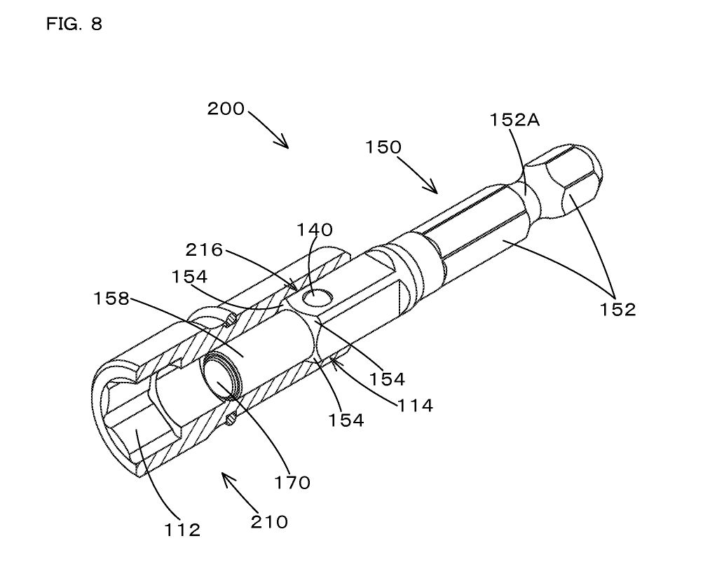

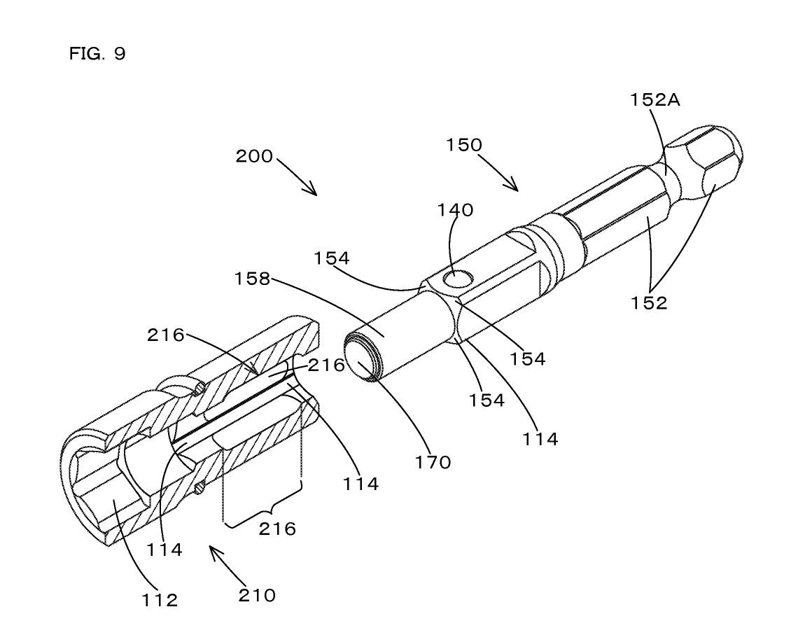

FIGS. 5A through 5C show a three-view drawing of the socket holder 200 that exemplifies the attachment for rotating tools in accordance with the second embodiment of the present invention. FIG. 5A is a top view of the socket holder 200, FIG. 5B is a side view showing part of the socket holder 200 in section, and FIG. 5C is a bottom view of the socket holder 200. Moreover, FIG. 6 is an enlarged sectional view taken along the line 6-6 in FIG. 5B. In addition, FIG. 7 is a perspective view showing the socket holder 200, with a magnet 170 staying toward a holding portion 112, FIG. 8 is a perspective view showing the socket holder 200, with the magnet 170 staying away from the holding portion 112, and FIG. 9 is an exploded perspective view of the socket holder 200.

As shown in FIGS. 5A through 9, the socket holder 200 is broadly composed of a cylindrical socket section 210 and a rodlike shank section 150 which is slidably held in the socket section 210 for transmission of torque to the socket section 210, and receives torque from a rotating tool. More specifically, the socket holder 200 comprises the shank section 150 which is a shank located toward one end of the socket holder 200 in the direction of the axis of rotation, to which is attached a rotating tool, and the socket section 210 located toward the other end of the socket holder 200, which has a holding portion 112 that engages with the head of a flanged hexagon-head drill screw. A coil spring 130 and a steel ball 140 provided in the shank section 150, and a ball sliding portion 216 provided in the socket section 210 constitute a retention mechanism (holding means). The shank section 150 is detachably and slidably fitted to the socket section 210 via the retention mechanism.

[Socket Section]

Now, the socket section 210 will be described in greater detail. The socket section 210 includes a sliding cavity in which the shank section 150 slides in the rotation-axis direction relative to the socket section 210, and the holding portion 112 in the form of a recess of hexagonal profile for holding a hexagonal head part of a drill screw acting as a fastening member in engagement. The sliding cavity is composed of a torque transmission portion 114 to which is transmitted torque from a rotating tool through the second torque transmission portion 154 of the shank section 150, and the ball sliding portion 216 for sliding the steel ball 140 of the shank section 150. The ball sliding portion 216 has the form of a slot created in the inner periphery of the sliding cavity. Moreover, the torque transmission portion 114 and the second torque transmission portion 154 are arranged in 90-degree rotationally symmetrical relation, wherefore four ball sliding portions 216 are provided in the inner periphery of the sliding cavity relative to a single steel ball 140. The ball sliding portion 216 is radiused at both ends in conformity with the diameter of the steel ball 140, and merges smoothly with the other part of the inner periphery of the sliding cavity. However, the ball sliding portion 216 is not limited to a four-piece configuration.

[Retention Mechanism]

Thus, the steel ball 140 is pressed into engagement in the ball sliding portion 216 by the coil spring 130. In this way, as is the case with the socket holder 100 of the first embodiment, the shank section 150 is made attachable to and detachable from the socket section 110, and besides, the shank section 150 is free to slide in the socket section 210.

The shank section 150 can be moved toward the holding portion 112 until it reaches a limit position where the magnetic force of the magnet 170 can be exerted on a drill screw which is to be held in the holding portion 112. On the other hand, the shank section 150 can be moved away from the holding portion 112 until it reaches a limit position where the shank section 150 is restrained against detachment from the socket section 210. Since the steel ball 140 is moved slidingly between one radiused end toward the holding portion 112, or approach radiused end, and the other radiused end away from the holding portion 112, or separation radiused end, of the ball sliding portion 216, it follows that the shank section 150 is free to move between a position toward the holding portion 112, or approach position, and a position away from the holding portion 112, or separation position.

Where the positioning of the shank section 150 is concerned, for example, the approach position may advisably be determined so that a drill screw can be held properly in the holding portion 112 (so that a drill screw will not be pushed out by the magnet 170). On the other hand, the separation position should preferably be determined so that the magnet 170 can be located away from the holding portion 112 to an extent that its magnetic force becomes too weak to be exerted on the holding portion 112. The situation in which no magnetic force is exerted on the holding portion 112 means that iron chippings will not adhere to the holding portion 112 under a magnetic force. The magnitude of the magnetic force of the magnet 170, the approach position, and the separation position are adjusted so as to satisfy the above requirement.

Moreover, the coil spring 130 has a resilience in an extent sufficient to achieve subsequently-described action (when the rotating tool is moved following the completion of operation, the magnet 170 is moved away from the holding portion 112 before the drill screw becomes detached from the holding portion 112) on one hand, and has a resilience in an extent sufficient to prevent easy separation of the shank section 150 from the socket section 210 (for example, separation caused by gravitation alone) on the other hand. As is the case with the socket holder 100 of the first embodiment, upon the shank section 150 being pulled so as to come out of the socket section 210, the steel ball 140 presses the coil spring 130 down for disengagement from the ball sliding portion 216, and consequently the shank section 150 can be removed from the socket section 210.

[Operation of Socket Holder]

The operation of the thusly constructed socket holder 200 of the second embodiment will be explained.

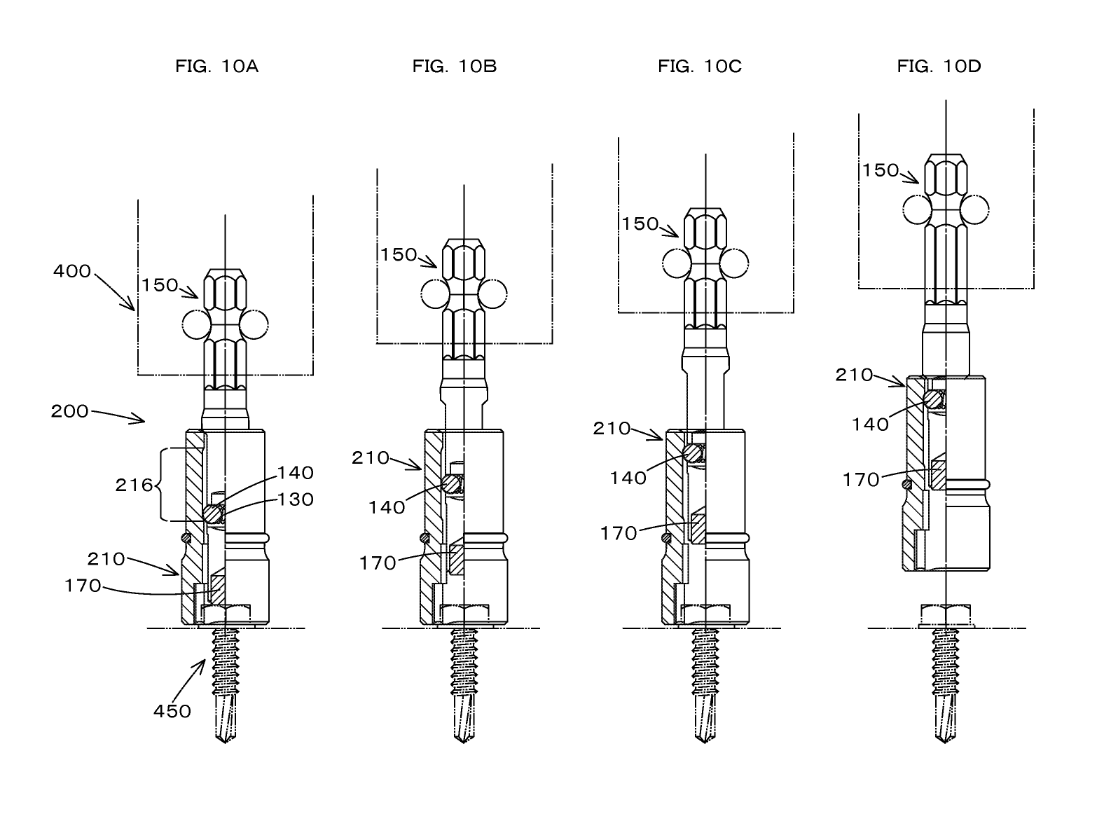

FIGS. 10A through 10D are diagrams of the socket holder 200 attached to a rotating tool 400, with a drill screw 450 held in it, illustrating changes of its state with time in the process of threading the drill screw 450 into a target member by the rotating tool 400.

In FIG. 10A, there is shown a state where the drill screw 450 has already been threaded in the target member, and the magnet 170 takes up a position nearest the holding portion 112 as it does in the middle of threading operation. In FIG. 10B, there is shown a state where the rotating tool 400 is being raised, and the magnet 170 is being moved away from the holding portion 112 correspondingly. In FIG. 10C, there is shown a state where the rotating tool 400 is being raised even further, and the magnet 170 takes up a position farthest away from the IC holding portion 112. In FIG. 10D, there is shown a state where the rotating tool 400 has been raised until the rotating tool 400 became detached from the drill screw 450, and the magnet 170 is maintained at the position farthest away from the holding portion 112.

As the rotating tool 400 in the position shown in FIG. 10A is moved upward by an operator, while the socket section 210 remains unraised, the shank section 150 alone held by the rotating tool 400 is raised in response to the upward movement of the rotating tool 400. That is, the shank section 150 is raised, whereas the socket section 210 remains unraised, wherefore the magnet 170 in the position nearest the holding portion 112 is moved away from the holding portion 112 (FIG. 10B). At this time, the drill screw 450 is kept held in the holding portion 112.

As the rotating tool 400, now staying in the position shown in FIG. 10B, is moved upward by the operator, while the socket section 210 remains unraised until the steel ball 140 abuts on the separation radiused end of the ball sliding portion 216, the shank section 150 alone held by the rotating tool 400 is raised in response to the upward movement of the rotating tool 400. At this time, the shank section 150 is raised, whereas the socket section 210 remains unraised until the magnet takes up the position farthest away from the holding portion 112 (FIG. 10C). At this time, the drill screw 450 is kept held in the holding portion 112.

As the rotating tool 400, now staying in the position shown in FIG. 10C, is further moved upward by the operator, with the steel ball 140 kept in contact with the separation radiused end of the ball sliding portion 216, in addition to the shank section 150 held by the rotating tool 400, the socket section 210 is also raised in response to the upward movement of the rotating tool 400. At this time, the magnet 170 is maintained in the position farthest away from the holding portion 112 (FIG. 10D). Then, the drill screw 450 is disengaged from the holding portion 112. Moreover, at this time, the steel ball 140 engaged in the ball engagement portion 116 is kept pressed under a resilient force exerted by the coil spring 130, wherefore it never occurs that the shank section 150 and the socket section 210 become detached from each other.

As shown in FIG. 10D, when the drill screw 450 is disengaged from the holding portion 112; that is, when a space is created where iron chippings may find their way into the holding portion 112, the magnet 170 takes up the position farthest away from the holding portion 112, wherefore no magnetic force is exerted on the holding portion 112. Accordingly, even if iron chippings, which are produced during the time the drill screw 450 is threaded into an iron sheet or the like with consequent formation of a tapping hole in the sheet by the cutting edge at the tip of the drill screw, find their way into the holding portion 112 in the state shown in FIG. 10D, since the magnetic force of the magnet 170 is not exerted on the holding portion 112, it never occurs that the iron chippings adhere to the holding portion 112.

[Advantageous Effects]

As described heretofore, according to the socket holder 200 of the second embodiment, in the case of pulling out the rotating tool following the completion of threading of the drill screw 450, so long as the magnetic force of the magnet 170 is exerted on the holding portion 112, the head of the drill screw 450 is held in engagement in the holding portion 112, wherefore no space will be created where iron chippings may find their way into the holding portion 112. Accordingly, the holding portion 112 is free from adhesion of iron chippings. Moreover, when the head of the drill screw 450 is disengaged from the holding portion 112, although a space where iron chippings may find their way into the holding portion 112 is created, the magnetic force of the magnet 170 is not exerted on the holding portion 112. Accordingly, the holding portion 112 is free from adhesion of iron chippings. As a result, there is provided the socket holder 200 which is capable of retention of the drill screw 450 with the aid of the magnet 170 in a very simple structure, and is free from adhesion of iron chippings produced during screw threading operation that occurs at the end of the operation. Moreover, even if iron chippings adhere to the magnet 170, as is the case with the socket holder 100, in the socket holder 200, since the shank section 150 can be readily detached from the socket section 210, it is possible to release the front end of the shank section 150 from the socket section 210, and thereby remove iron chippings adherent to the magnet 170 with safety.

### Third Embodiment

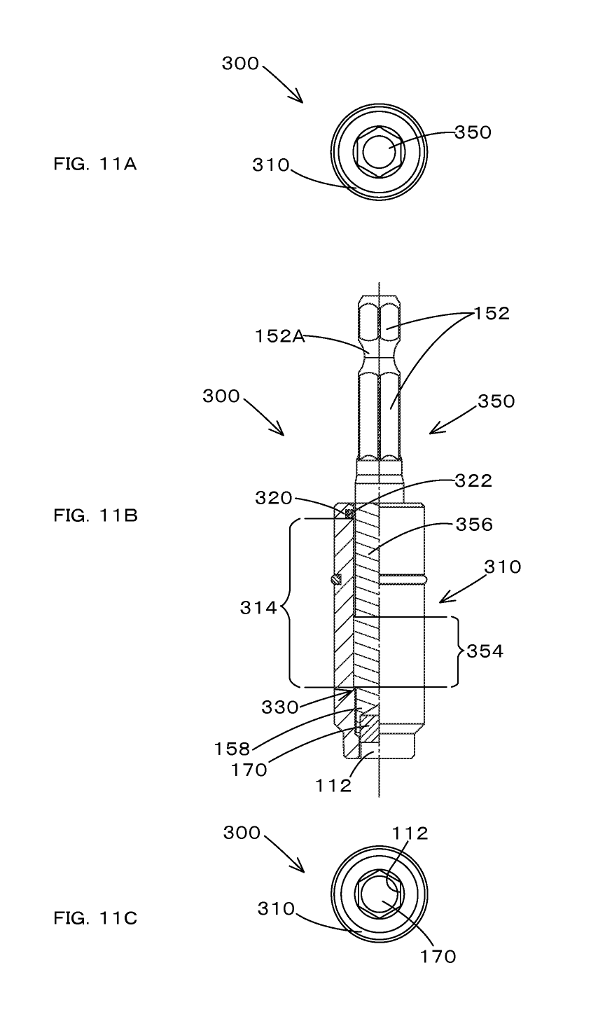

Hereinafter, a description will be given as to a socket holder 300 that exemplifies an attachment for rotating tools in accordance with the third embodiment of the present invention. The socket holder 300 differs from the socket holder 200 of the second embodiment in that a shank section 350, while being made undetachable, is slidably fitted to a socket section 310 via a retention mechanism. The constituent components (parts) of the socket holder 300 common to those of the socket holder 100 will be identified with the same reference symbols. These components are identical in name and function with the corresponding ones of the socket holder 100, wherefore overlapping descriptions will be omitted. Moreover, in what follows, FIGS. 11A through 11C, FIG. 12, FIG. 13, and FIGS. 14A through 14D correspond to FIGS. 5A through 5C, FIG. 7, FIG. 8, and FIGS. 10A through 10D, respectively.

[Structure of Socket Holder]

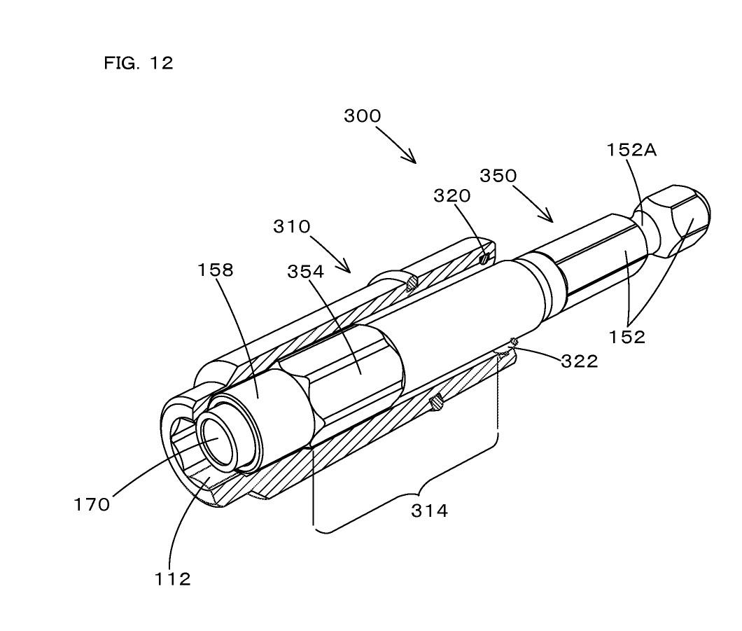

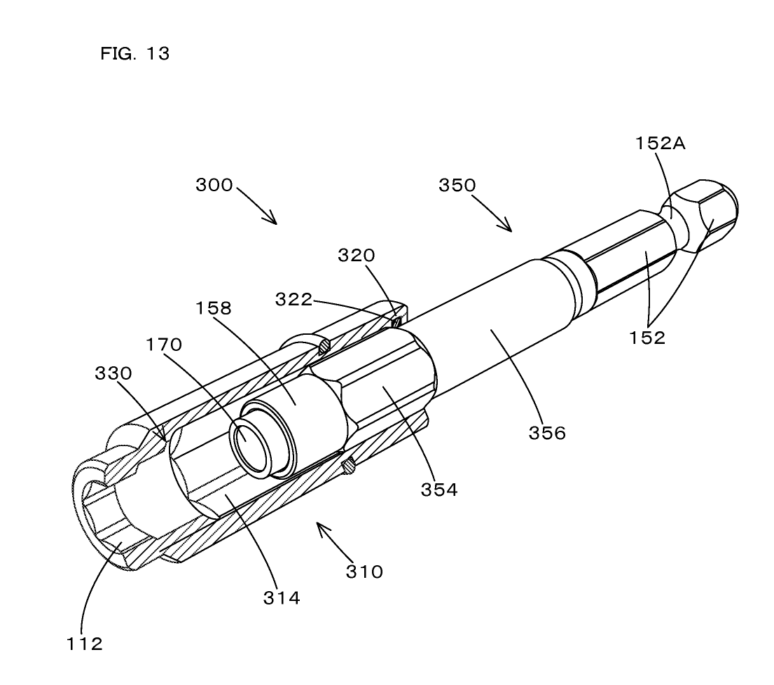

FIGS. 11A through 11C show a three-view drawing of the socket holder 300 that exemplifies the attachment for rotating tools in accordance with the third embodiment of the present invention. FIG. 11A is a top view of the socket holder 300, FIG. 11B is a side view showing part of the socket holder 300 in section, and FIG. 11C is a bottom view of the socket holder 300. Moreover, FIG. 12 is a perspective view showing the socket holder 300, with a magnet 170 staying toward a holding portion 112, and FIG. 13 is a perspective view showing the socket holder 300, with the magnet 170 staying away from the holding portion 112.

As shown in FIGS. 11A through 13, the socket holder 300 is broadly composed of a cylindrical socket section 310 and a rodlike shank section 350 which is slidably held in the socket section 310 for transmission of torque to the socket section 310, and receives torque from a rotating tool. More specifically, the socket holder 300 comprises the shank section 350 which is a shank located toward one end of the socket holder 300 in the direction of the axis of rotation, to which is attached a rotating tool, and the socket section 310 located toward the other end of the socket holder 300, which has a holding portion 112 that engages with the head of a flanged hexagon-head drill screw. A second torque transmission portion 354 and a cylindrical portion 356 provided in the shank section 350, and a C pin 322 engaged in a C pin slot 320 provided in the socket section 310 constitute a retention mechanism (holding means). The shank section 350 is slidably fitted to the socket section 310 via the retention mechanism.

[Shank Section]

Now, the shank section 350 will be described in greater detail. The shank section 350 is composed of a first torque transmission portion 152 to which is transmitted torque from a rotating tool, the second torque transmission portion 354 for transmitting torque to the socket section 310, the cylindrical portion 356 situated between the first torque transmission portion 152 and the second torque transmission portion 354, and a cylindrical magnet holding portion 158 for holding the magnet 170. The magnet holding portion 158 is smaller in O.D. dimension than a hexagonal prism which defines the form of the second torque transmission portion 354.

The second torque transmission portion 354 is given the form of a hexagonal prism (although there is no particular limitation, a hexagonal prism of 6.35 mm in opposite side length). The six sides of the second torque transmission portion 354 abut on the inner surface of a torque transmission portion 314 in the form of a recess of hexagonal profile constituting the sliding cavity of the socket section 310, whereby torque can be transmitted from the shank section 350 to the socket section 310. In this case, the inside dimension of the hexagonal-profile recess-shaped torque transmission portion 314 of the socket section 310 is adjusted to be larger than the O.D. dimension of the hexagonal prism-shaped second torque transmission portion 354 of the shank section 350 in an extent sufficient to permit sliding motion of the shank section 350 in the socket section 310 and torque transmission from the shank section 350 to the socket section 310.

The O.D. dimension of the cylindrical portion 356 is smaller than the O.D. dimension of the hexagonal prism-shaped second torque transmission portion 354. The O.D. dimension of the cylindrical portion 356 is substantially the same as, or slightly smaller than the I.D. dimension of the subsequently-described C pin 322 in an extent sufficient to permit sliding motion of the shank section 350 in the socket section 310. The I.D. dimension of the C pin 322 is smaller than the O.D. dimension of the hexagonal prism-shaped second torque transmission portion 354. That is, the following relationship holds: the O.D. dimension of the cylindrical portion 356≦the I.D. dimension of the C pin 322<the O.D. dimension of the hexagonal prism-shaped second torque transmission portion 354.

The magnet holding portion 158 is substantially equal in O.D. dimension to the cylindrical portion 356. The O.D. dimension of the magnet holding portion 158, as well as the O.D. dimension of the cylindrical portion 356, is smaller than the O.D. dimension of the hexagonal prism-shaped second torque transmission portion 354. The cylindrical magnet 170 is smaller in O.D. dimension than the magnet holding portion 158.

[Socket Section]

Now, the socket section 310 will be described in greater detail. The socket section 310 includes a sliding cavity in which the shank section 350 slides in the rotation-axis direction relative to the socket section 310, and the holding portion 112 in the form of a hexagonal-profile recess disposed at the front end of the socket section 310, for holding a hexagonal head part of a drill screw acting as a fastening member in engagement. The sliding cavity is composed of the torque transmission portion 314 to which is transmitted torque from a rotating tool through the second torque transmission portion 354 of the shank section 350, and a C pin slot 320 for holding the C pin 322 acting as a retainer for the shank section 350 in engagement. The C pin 322 having the above-described dimension is held in engagement in the C pin slot 320. The second torque transmission portion 354 slides in the torque transmission portion 314. Moreover, the second torque transmission portion 354 is given the form of a hexagonal prism, and correspondingly the torque transmission portion 314 is given the form of a recess of hexagonal profile (inscribed hexagon) for internal connection with the outer surface of the hexagonal prism-shaped second torque transmission portion 354. Thus, the torque transmission portion 314 and the second torque transmission portion 354 are each regular hexagonal in cross section, wherefore the shank section 350 can be inserted into the socket section 310 on a 60-degree turn basis.

A holding portion 112-sided part of the socket section 310 is stepped to provide a shoulder part 330. The shoulder part 330 is a reduced diameter part, the diameter dimension of which is reduced from the I.D. dimension of the torque transmission portion 314 to an I.D. dimension smaller than the O.D. dimension of the second torque transmission portion 354. The smaller I.D. dimension is larger than the O.D. dimension of the magnet holding portion 158.

[Retention Mechanism]

Thus, the I.D. dimension of the C pin 322 is larger than the O.D. dimension of the cylindrical portion 356, yet is smaller than the O.D. dimension of the hexagonal prism-shaped second torque transmission portion 354. Therefore, when the second torque transmission portion 354 slides toward the separation position, the C pin 322 acts to retain the second torque transmission portion 354, so that the shank section 350 can be prevented from coming out of the socket section 310. Moreover, the reduced I.D. dimension of the shoulder part 330 is larger than the O.D. dimension of the magnet holding portion 158, yet is smaller than the O.D. dimension of the second torque transmission portion 354. Therefore, when the second torque transmission portion 354 slides toward the approach position, the shoulder part 330 acts to retain the second torque transmission portion 354, so that the shank section 350 can be prevented from coming out of the socket section 310.

Moreover, the inside dimension of the hexagonal-profile recess-shaped torque transmission portion 314 of the socket section 310 is larger than the O.D. dimension of the hexagonal prism-shaped second torque transmission portion 354 of the shank section 350. Therefore, the shank section 350 is free to slide in the socket section 310 between the approach position toward the holding portion 112 and the separation position away from the holding portion 112. Note that the limit of approach of the shank section 350 to the holding portion 112 and the limit of separation of the shank section 350 from the holding portion 112 are the same as those set for the socket holder 200 of the second embodiment.

In addition, the difference between the inside dimension of the hexagonal-profile recess-shaped torque transmission portion 314 and the O.D. dimension of the hexagonal prism-shaped second torque transmission portion 354 is in an extent sufficient to achieve the subsequently-described action (when the rotating tool is moved following the completion of operation, the magnet 170 is moved away from the holding portion 112 before the drill screw becomes detached from the holding portion 112).

[Operation of Socket Holder]

The operation of the thusly constructed socket holder 300 of the third embodiment will be explained.

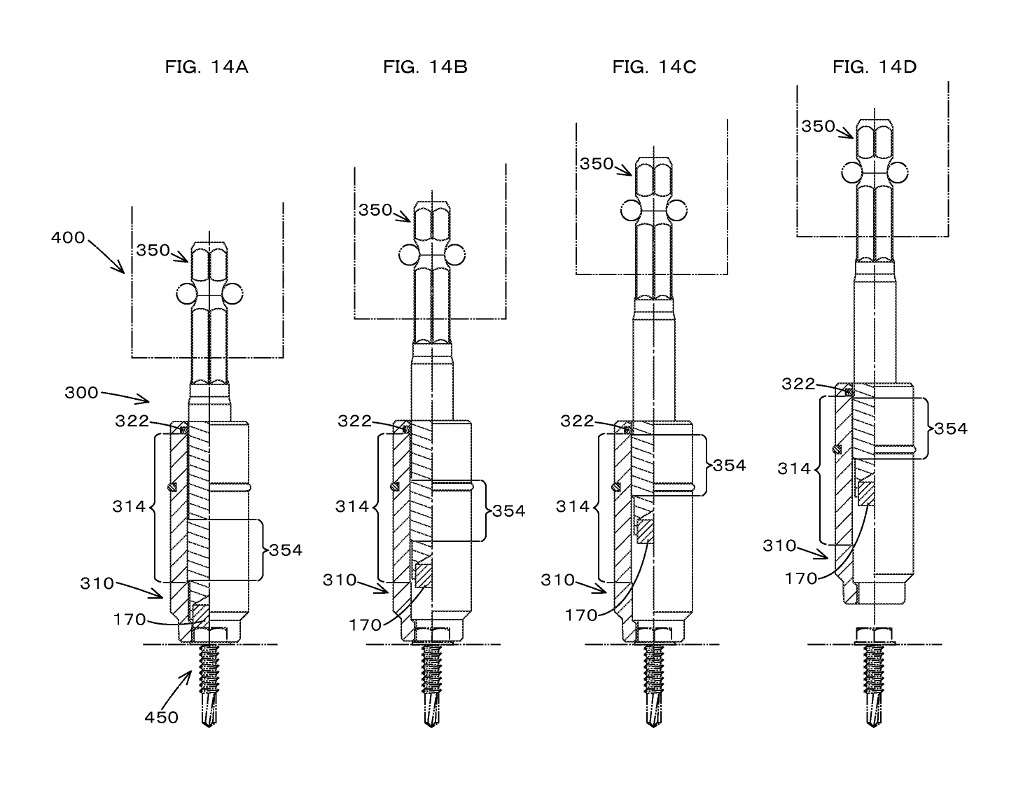

FIGS. 14A through 14D are diagrams of the socket holder 300 attached to a rotating tool 400, with a drill screw 450 held in it, illustrating changes of its state with time in the process of threading the drill screw 450 into a target member by the rotating tool 400. FIG. 14A, FIG. 14B, FIG. 14C, and FIG. 14D correspond to FIG. 10A, FIG. 10B, FIG. 10C, and FIG. 10D, respectively.

As the rotating tool 400 in the position shown in FIG. 14A is moved upward by an operator, while the socket section 310 remains unraised, the shank section 350 alone held by the rotating tool 400 is raised in response to the upward movement of the rotating tool 400. That is, the shank section 350 is raised, whereas the socket section 310 remains unraised, wherefore the magnet 170 in the position nearest the holding portion 112 is moved away from the holding portion 112 (FIG. 14B). At this time, the drill screw 450 is kept held in the holding portion 112.

As the rotating tool 400, now staying in the position shown in FIG. 14B, is moved upward by the operator, while the socket section 310 remains unraised until the second torque transmission portion 354 abuts on the C pin 322, the shank section 350 alone held by the rotating tool 400 is raised in response to the upward movement of the rotating tool 400. At this time, the shank section 350 is raised, whereas the socket section 310 remains unraised until the magnet 170 takes up the position farthest away from the holding portion 112 (FIG. 14C). At this time, the drill screw 450 is kept held in the holding portion 112.

As the rotating tool 400, now staying in the position shown in FIG. 14C, is further moved upward by the operator, with the second torque transmission portion 354 kept in contact with the C pin 322, in addition to the shank section 350 held by the rotating tool 400, the socket section 310 is also raised in response to the upward movement of the rotating tool 400. At this time, the magnet 170 is maintained in the position farthest away from the holding portion 112 (FIG. 14D). Then, the drill screw 450 is disengaged from the holding portion 112. Moreover, at this time, the second torque transmission portion 354 is kept in contact with the C pin 322, and the C pin 322 is held in engagement in the C pin slot 320, wherefore it never occurs that the shank section 350 and the socket section 310 become detached from each other.

As shown in FIG. 14D, when the drill screw 450 is disengaged from the holding portion 112; that is, when a space is created where iron chippings may find their way into the holding portion 112, the magnet 170 takes up the position farthest away from the holding portion 112, wherefore no magnetic force is exerted on the holding portion 112. Accordingly, even if iron chippings, which are produced during the time the drill screw 450 is threaded into an iron sheet or the like with consequent formation of a tapping hole in the sheet by the cutting edge at the tip of the drill screw 450, find their way into the holding portion 112 in the state shown in FIG. 14D, since the magnetic force of the magnet 170 is not exerted on the holding portion 112, it never occurs that the iron chippings adhere to the holding portion 112.

[Advantageous Effects]

As described heretofore, according to the socket holder 300 of the third embodiment, as is the case with the socket holder 200 of the second embodiment, the holding portion 112 is free from adhesion of iron chippings. As a result, there is provided the socket holder 300 which is capable of retention of the drill screw 450 with the aid of the magnet 170 in a very simple structure, and is free from adhesion of iron chippings produced during screw threading operation that occurs at the end of the operation.

### MODIFICATION EXAMPLES

The following are descriptions as to examples of modified form of the embodiments thus far described.

For example, in the earlier described first embodiment, the shank section 150 is held for free detachment from the socket section 110 by the retention mechanism composed of: the coil spring 130 and the steel ball 140 provided in the shank section 150; and the ball engagement portion 116 provided in the socket section 110. Alternatively, the steel ball 140 may be provided in the socket section 110 instead of being provided in the shank section 150. That is, the shank section 150 may be held for free detachment from the socket section 110 by a retention mechanism composed of: a ring spring and a steel ball provided in the socket section; and a ball engagement portion provided in the shank section.

Moreover, in the earlier described second embodiment, the shank section 150 is held for free sliding motion, as well as for free detachment from the socket section 210, by the retention mechanism composed of: the coil spring 130 and the steel ball 140 provided in the shank section 150; and the ball sliding portion 216 provided in the socket section 210. Alternatively, the steel ball 140 may be provided in the socket section 210 instead of being provided in the shank section 150. That is, the shank section 150 may be held for free sliding motion, as well as for free detachment from the socket section 210, by a retention mechanism composed of: a ring spring and a steel ball provided in the socket section; and a ball sliding portion provided in the shank section.

Furthermore, in the earlier described third embodiment, the shank section 350 is held for free sliding motion in the socket section 310 by the retention mechanism composed of the C pin slot 320 and the C pin 322 provided in the socket section 310. Alternatively, the C pin slot 320 and the C pin 322 may be provided in the shank section 350 instead of being provided in the socket section 310.

In addition, although the description of the second embodiment with reference to FIGS. 10A through 10D, as well as the description of the third embodiment with reference to FIGS. 14A through 14D, deals with the case of threading the drill screw in the downward direction with use of the rotating tool, and moving the rotating tool in the upward direction, the application of the present invention is not limited to such a case. Even in the case of threading the drill screw in the upward direction with use of the rotating tool and moving the rotating tool in the downward direction, or even in the case of threading the drill screw in one sideward direction with use of the rotating tool and pulling out the rotating tool in the other sideward direction, since the shank section 150 or the shank section 350 is free to slide between the approach position toward the holding portion 112 and the separation position away from the holding portion 112, it is possible to achieve the same effect as intended.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

1. An attachment for rotating tools, which is attached to a rotating tool for rotation of a fastening member, comprising:
a cylindrical socket section; and
a rodlike shank section which is slidably held in said socket section for transmission of torque to said socket section, and receives torque from said rotating tool,
said shank section having a magnet member fitted to a front end thereof,
said socket section including:
a sliding cavity in which said shank section slides in a direction of an axis of rotation relative to said socket section; and
a holding portion disposed on a front-end side thereof, for holding said fastening member in engagement,
said attachment including holding means disposed in at least one of that part of said socket section which bears said sliding cavity and said shank section, for holding said shank section for free detachment from said socket section.

2. The attachment for rotating tools according to claim 1,
wherein said fastening member is any one of a hexagon head drill screw, a hexagon head tapping screw, and a hexagon head drilling tapping screw,
and wherein said holding portion has a form of a recess of hexagonal profile.

3. The attachment for rotating tools according to claim 1,
wherein said fastening member is a bit for rotating any one of a cross- or square-recessed head drill screw, a cross- or square-recessed head tapping screw, and a cross- or square-recessed head drilling tapping screw,
and wherein said holding portion is given a cross-like or rectangular profile, and has a bit holder part for holding said bit.

4. An attachment for rotating tools, which is attached to a rotating tool for rotation of a fastening member, comprising:
a cylindrical socket section; and
a rodlike shank section which is slidably held in said socket section for transmission of torque to said socket section, and receives torque from said rotating tool,
said shank section having a magnet member fitted to a front end thereof,
said socket section including:
a sliding cavity in which said shank section slides in a direction of an axis of rotation relative to said socket section; and
a holding portion disposed on a front-end side thereof, for holding said fastening member in engagement,
said attachment including slidably holding means for holding said shank section for free sliding motion in said socket section in a manner such that said shank section is able to move toward and away from said holding portion, and that said shank section moves away from said holding portion as said rotating tool is moved in a direction to move said fastening member away from said holding portion.

5. The attachment for rotating tools according to claim 4,
wherein said slidably holding means holds said shank section for free sliding motion in said socket section, is disposed in at least one of that part of said socket section which bears said sliding cavity and said shank section, and holds said shank section for free detachment from said socket section.

6. The attachment for rotating tools according to claim 4,
wherein said shank section can be moved away from said holding portion until it reaches a limit position where said shank section is restrained against detachment from said socket section.

7. The attachment for rotating tools according to claim 4,
wherein said shank section is free to slide between an approach position toward said holding portion and a separation position away from said holding portion.

8. The attachment for rotating tools according to claim 4,
wherein said fastening member is any one of a hexagon head drill screw, a hexagon head tapping screw, and a hexagon head drilling tapping screw,
and wherein said holding portion has a form of a recess of hexagonal profile.

9. The attachment for rotating tools according to claim 4,
wherein said fastening member is a bit for rotating any one of a cross- or square-recessed head drill screw, a cross- or square-recessed head tapping screw, and a cross- or square-recessed head drilling tapping screw,
and wherein said holding portion is given a cross-like or rectangular profile, and has a bit holder part for holding said bit.
